(19) United States
(12) Patent Application Publication
(10) Pub. No.: US 2016/0023329 A1
(43) Pub. Date: Jan. 28, 2016

(54) CENTRIC CLAMPING DEVICE

(71) Applicant: GRESSEL AG, Aadorf (CH)

(72) Inventor: Marcel SCHLÜSSEL, Bassersdorf (CH)

(21) Appl. No.: 14/805,020

(22) Filed: Jul. 21, 2015

(30) Foreign Application Priority Data
Jul. 23, 2014 (DE) 10 2014 110 352.1

(51) Int. Cl. B25B 1/10; B25B 1/24

(52) U.S. Cl. CPC B25B 1/103; B25B 1/2489

(57) ABSTRACT

A centric clamping device, which contains a main body, two clamping jaws, guided so they can be displaced on the main body, and an adjusting spindle, supported by a spindle bearing so that it can rotate on the main body for the opposing adjustment of the two clamping jaws. A high-precision spindle bearing, optimally protected against soiling, is attained in that the spindle bearing is located in a bearing block and two bearing sleeves, which can be adjusted axially within the bearing block.

### FIELD OF THE DISCLOSURE

The disclosure concerns a centric clamping device.

### BACKGROUND

Centric clamping devices usually have a main body, which can be clamped, for example, on a machine table, two clamping jaws that are guided so they can be displaced on the main body via longitudinal guides, and an adjusting spindle for the opposing adjustment of the two clamping jaws. With the aid of the adjusting spindles, the clamping jaws, situated so they can be displaced on the main body, can be simultaneously moved apart and together, wherein a centric clamping of workpieces is made possible.

From DE 10 2012 112 755 A1, a generic centric clamping device is known. It has a main body, two clamping jaws that are guided so they can be displaced on the main body, and an adjusting spindle that is supported on the main body so it can rotate by means of a spindle bearing for the opposing adjustment of the two clamping jaws. In this known clamping device, the spindle support consists of a bearing support that is affixed to the main body by means of screws, which contains a shell-shaped bearing bridge to engage with an annular groove of the adjusting spindle.

In DE 20 2004 009 517 U1, a clamping device with a main body and two clamping jaws is disclosed; the jaws are situated opposite one another on the main body and are guided in a displaceable manner toward one another and away from one another along a common axle. The adjustment of the clamping jaws is carried out via an adjusting spindle, which is supported so it can rotate in a central bearing housing and, on its end sections, has external threaded sections with opposite gradients, which are screwed into the clamping jaws.

DE 10 2013 104 467 A1 discloses a centric clamping device in which two clamping jaws that can be adjusted contrary to one another on a main body are guided in such a manner that they can be displaced. The clamping jaws can be adjusted via a threaded spindle that is supported so it can rotate in a middle bearing block.

DE 297 23 435 U1 discloses a centric clamping device with two linearly guided clamping slides that can be moved relative to one another. The adjustment of the clamping slides is carried out by a threaded spindle that is supported so it can rotate within a bearing block; the spindle has opposing threaded sections on its two ends for engagement with threaded nuts of two pistons.

From EP 1 688 219 A1 is known a clamping device with a first clamping jaw that is firmly situated on a main body and a second clamping jaw that is guided so it can be adjusted on the main body. The second clamping jaw can be adjusted by means of a screw spindle that is situated in a spindle recess of the main body. To avoid soiling, the spindle recess of the main body between the two clamping jaws is covered by a cover element over the entire adjustment section of the clamping jaws.

DE 10 2007 027 808 B3 concerns a clamping device in which the carriers of the clamping jaws are designed as half-shells that enclose the adjusting spindle.

### SUMMARY OF THE DISCLOSURE

A centric clamping device, which contains a high-accuracy spindle bearing that is optimally protected against soiling is disclosed. Appropriate refinements and advantageous embodiments are also disclosed.

In the centric clamping device in accordance with the invention, the spindle bearing is located in a bearing block and has two bearing sleeves which can be adjusted axially within the bearing block. By means of the axial adjustment of the two bearing sleeves, it is possible to not only set the axial position of the adjusting spindle relative to the main body, but via a contrary adjustment of the two bearing sleeves, the spindle bearing can also be pretensioned and adjusted free of play. In this way, a high degree of precision and a good repeatability can be attained. Furthermore, the adjusting spindle over the bearing block can be completely covered and sealed in the section of the bearing. The centric clamping device is thus impervious to chips and the adjusting spindle is protected against soiling in a closed system.

In an embodiment that can be adjusted in a particularly low-friction and precise-position manner, the spindle bearing can be designed as a roller bearing with several rolling elements conducted between the bearing sleeves and the adjusting spindle. For this, the adjusting spindle can have, for example, annular grooves at a distance from one another for the inside bearing of the rolling elements designed, for example, as spheres. The two bearing sleeves can contain a shoulder-shaped bearing surface on the front sides, facing one another, for the outside bearing of the rolling elements. By the mutual clamping of the two bearing sleeves, the shoulder-shaped bearing surfaces can be stopped at the spheres and an adjustment that is as free of play as is possible can thus be attained. However, the spindle bearing could also be designed as a slide bearing with axially adjustable slide bearing sleeves.

A simple axial adjustment of the bearing sleeves can be attained in that the two bearing sleeves have an external thread for engagement with a corresponding internal thread of a passage opening running through the bearing block.

In a particularly stable design, which is optimally protected from soiling, the bearing block, closed over its entire circumference, can be designed as a single part with the main body. An optimized chip discharge can be attained in that passages are arranged that have bottom surfaces leading downward at an incline, and also leading outward from indentations between the bearing block and two side wings of the main body.

In accordance with another advantageous embodiment, the two clamping jaws can be adjusted via sliders guided in a displaceable manner in the main body. The sliders can be incorporated into the main body in such a manner that a design is produced that is protected from soiling and impervious to chips. The adjusting spindle appropriately has two external threads that are made as right or left threads for engagement with corresponding internal threads on passage boreholes of the two sliders.

The clamping jaws are advantageously detachably fastened on the sliders. In this way, it is possible to replace the clamping jaws according to need and they can be adapted to the individual clamping task. The clamping jaws can have any arbitrary form.

### BRIEF DESCRIPTION OF THE DRAWINGS

Other features and advantages of the disclosure can be deduced from the following description of a preferred embodiment example, with the aid of the drawing. The figures show the following:

FIG. 1, a centric clamping device in accordance with the invention in a perspective from above;

FIG. 2, the centric clamping device of FIG. 1 in a perspective from below;

FIG. 3, the centric clamping device of FIG. 1 in a top view;

FIG. 4, the centric clamping device of FIG. 1 in a longitudinal section along the A-A line of FIG. 3;

FIG. 5, an enlarged detail view of area C of FIG. 4;

FIG. 6, the centric clamping device of FIG. 1 in a side view;

FIG. 7, a cross section along line B-B of FIG. 6; and

FIG. 8, an enlarged detail view of area D of FIG. 7.

### DETAILED DESCRIPTION

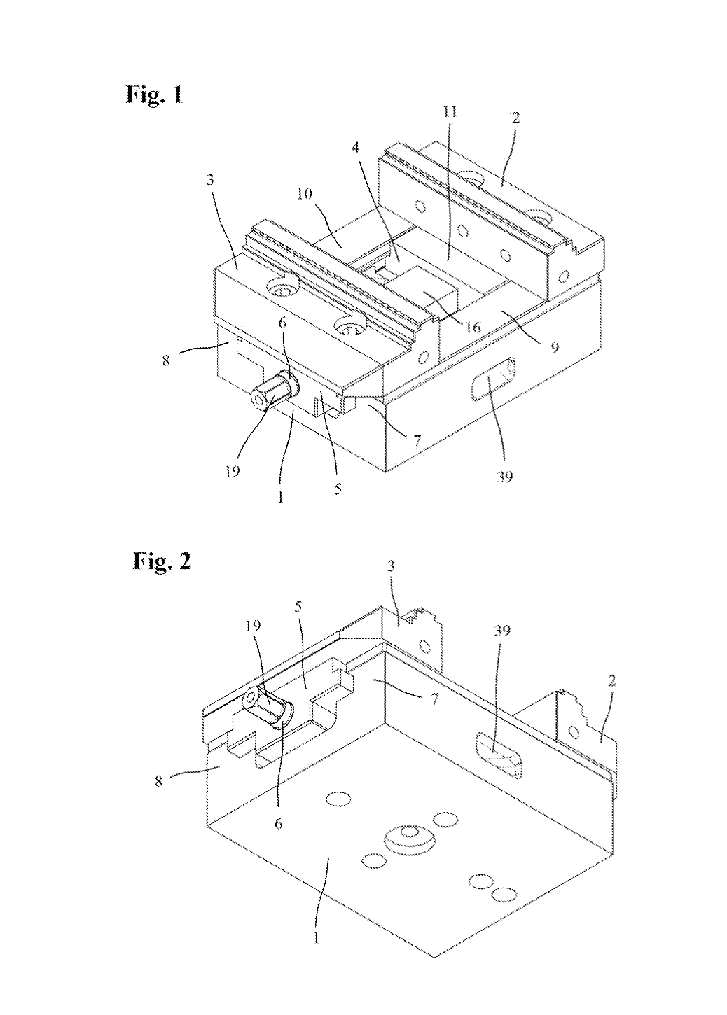

The centric clamping device shown in FIGS. 1 to 4 in different views contains a main body 1, on which two clamping jaws 2 and 3 are guided in a displaceable manner over sliders 4 and 5 and which can be adjusted in opposite directions by means of an adjusting mechanism with an adjusting spindle 6. The main body 1 has two side wings 7 and 8, at a distance from one another, with upper guide surfaces 9 and 10. In the embodiment shown, the two guide surfaces 9 and 10 are constructed on one hardened and ground upper part of the two side wings 7 and 8 of the main body 1. The guide surfaces 9 and 10, however, can also be situated on separate guide tracks or guide bars that can be replaced according to need. Between the two side wings 7 and 8 of the main body 1, the two sliders 4 and 5 are adapted and guided in such a way that they can be displaced. In the embodiment example shown, the sliders 4 and 5 have a step-shaped cross section with an upper stop surface 11.

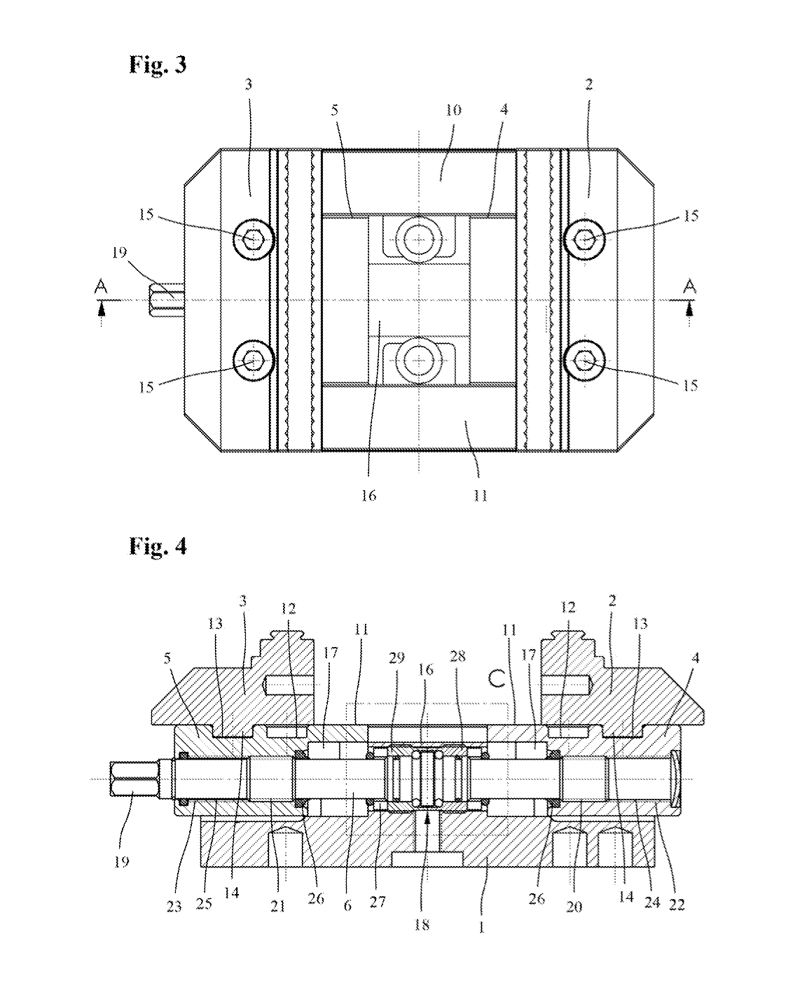

As can be seen from FIG. 4, the upper stop surface 11 of each of the sliders 4 and 5 has two indentations 12 and 13 lying in the longitudinal direction of the main body 1, as seen one behind the other, for the form-locking engagement of an attachment 14 that projects downward from the underside of the clamping jaws 2 and 3. In this way, the clamping jaws 2 and 3 can be staggered inward or outward and can be fastened in a precise position on the individual sliders 4 or 5 by screws 15, which can be seen in FIG. 3. The clamping jaws 2 and 3 can have an arbitrary form that is adapted to the individual clamping task. In the embodiment shown, the clamping jaws 2 and 3 are made as reversible jaws with various clamping surfaces.

By turning the clamping jaws 2 and 3, it is thus possible to simply expand or change the clamping section.

In the middle of the main body 1, between the two side wings 7 and 8, there is a bearing block 16, closed toward the top and to the side, for the support of the adjusting spindle 6. The two sliders 4 and 5 each have a recess 17 or a cover, on the front sides, facing one another, to hold the bearing block 16 and to cover the adjusting spindle 6. In this way, the two sliders 4 and 5 are pushed together over the bearing block 16, with the covering of the adjusting spindle 6. By means of the recesses 17 or the covers on the sliders 4 and 5, the adjusting spindle 6 is covered and the chips are deflected. Within the bearing block 16, the adjusting spindle 6 can be rotated around its longitudinal axle by a spindle bearing 18, which is explained in more detail below, and is securely supported in the axial direction.

From FIG. 4, one can see that the adjusting spindle 6, supported in the middle within the bearing block 16, contains an adjusting pin 19 that projects outward, opposite the main body 1 and the slider 5, and is provided here with an external hexagon, and two external threads 20 and 21, constructed as right or left threads, for engagement with corresponding internal threads 22 and 23 in passage boreholes 24 and 25 of the two sliders 4 and 5. By rotating the adjusting pin 19 with the aid of a suitable hand crank or another activation element, the two sliders 4 and 5 can thus be pushed opposite one another and the clamping jaws 2 and 3 can thus be simultaneously moved together or apart. Via ring-shaped sealing elements 26, the two sliders 4 and 5 are sealed on their front sides, facing one another, opposite the adjusting spindle 6.

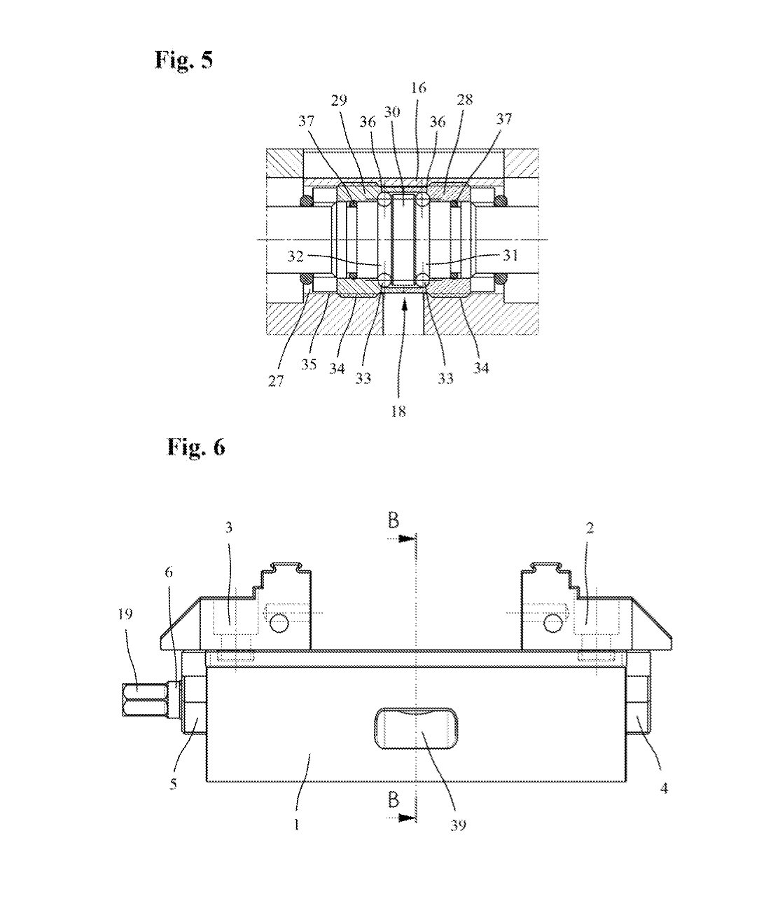

In the embodiment shown, the bearing block 16, shown in detail in FIG. 5, is made as one single part with the main body 1 and contains a passage opening 27, running in the longitudinal direction of the main body 1, in which the spindle bearing 18 for the adjusting spindle 6 is located. The spindle bearing 18 comprises two bearing sleeves 28 and 29, which are situated in such a way that they can be adjusted axially within the passage opening 27 and in which the adjusting spindle 6 is supported so it can rotate. The adjusting spindle 6 contains a central coil 30 and two annular grooves 31 and 32, which are provided to the right and left of the coil 30 and in which rolling elements 33, which are distributed over the circumference of the adjusting spindle 6, are supported. The two bearing sleeves 28 and 29 have an external thread 34 for engagement with a corresponding internal thread 35 of the passage opening 27 and on the front sides, facing one another, contain a shoulder-shaped bearing surface 36, on which the rolling elements 33, guided on the inside into two annular grooves 31 and 32 and designed here as spheres, stop on the outside. By a parallel adjustment of the two bearing sleeves 28 and 29 within the bearing block 16, the position of the adjusting spindle 6 can be set relative to the main body 1. The spindle bearing 18, on the other hand, can be pretensioned and adjusted free of play via a reciprocal adjustment of the two bearing sleeves 28 and 29.

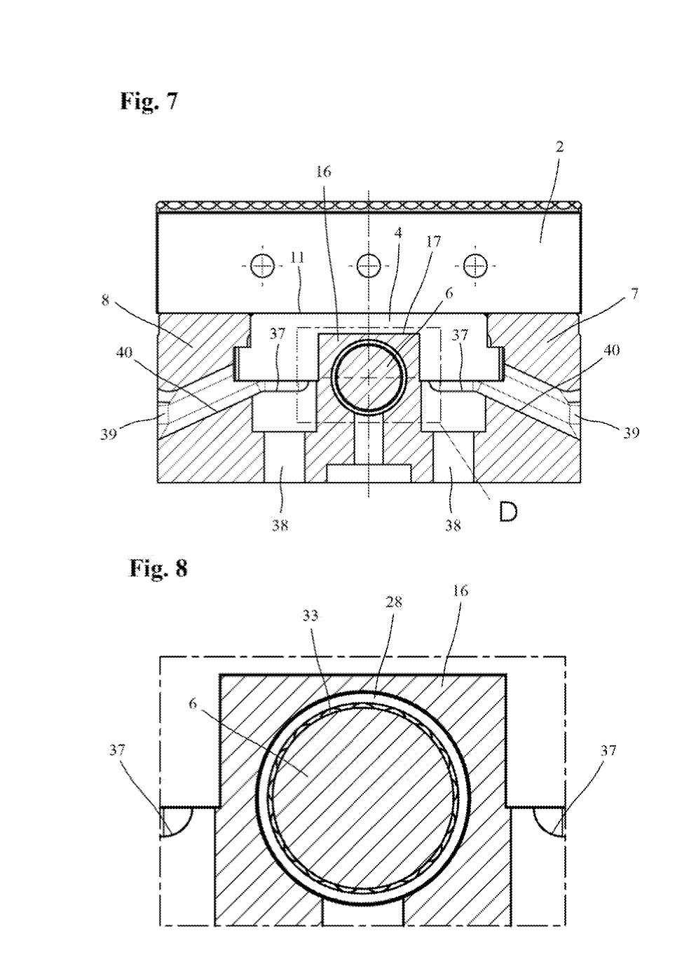

In FIGS. 7 and 8, the central bearing block 16, located between the two side wings of the main body 1, is shown in cross section. Between the bearing block 16 and the two side wings 7 and 8 of the main body 1, indentations 37 with counterbores 38 are provided for the fastening of the main body 1 on a machine table or the like. In the two side wings 7 and 8, there are passages 39, guided outward from the indentations 37, with bottom surfaces 40, guided downward at an incline. In this way, chips arriving at the indentations 37 can be conducted outward in a simple and effective manner. By the recesses 17 or the covers on the sliders 4 and 5, the adjusting spindle 6 and also the bearing block 16 are covered and the chips are deflected to the indentations 37, and from there, via the passages 39, to the outside.

In the embodiment shown, the two clamping jaws 2 and 3 are designed as reversible jaws and have straight clamping surfaces on one side and stepped clamping surfaces on the other side. By turning the clamping jaws 2 and 3, the clamping section can thus be expanded in a simple manner. The clamping jaws 2 and 3, however, can also have any other, arbitrary form, adapted to the individual clamping task.

What is claimed is:

1. Centric clamping device, which contains a main body, two clamping jaws, guided so the clamping jaws are displaceable on the main body, and an adjusting spindle, supported by means of a spindle bearing so the spindle is rotatable on the main body for opposing adjustment of the two clamping jaws, wherein the spindle bearing is located in a bearing block and contains two bearing sleeves that are adjustable axially within the bearing block.

2. Centric clamping device according to claim 1, wherein the spindle bearing is a roller bearing with several rolling elements, located between the bearing sleeves and the adjusting spindle.

3. Centric clamping device according to claim 2, wherein the adjusting spindle contains two annular grooves, at a distance from one another, for the inside bearing of the roller bodies.

4. Centric clamping device according to claim 2, wherein the two bearing sleeves have shoulder-shaped bearing surfaces on their front sides, facing one another, for the outside bearing of the roller bodies.

5. Centric clamping device according to claim 1, wherein the two bearing sleeves have an external thread for engagement with a corresponding internal thread of a passage opening that runs through the bearing block.

6. Centric clamping device according to claim 1, wherein the bearing block is a single part with the main body.

7. Centric clamping device according to claim 1, wherein the two clamping jaws can be adjusted via sliders, guided so they can be displaced in the main body.

8. Centric clamping device according to claim 7, wherein the adjusting spindle contains two external threads, made as right or left threads, for engagement with corresponding internal threads on passage boreholes of the two sliders.

9. Centric clamping device according to claim 7, wherein the two clamping jaws are detachably fastened on the sliders.

10. Centric clamping device according to claim 7, wherein the two sliders each have a recess or a cover on the front sides, facing one another, to hold the bearing block and for the covering of the adjusting spindle.

11. Centric clamping device according to claim 1, wherein the bearing block is located between two side wings of the main body.

12. Centric clamping device according to claim 11, wherein indentations are located between the bearing block and the two side wings.

13. Centric clamping device according to claim 12, wherein, in the two side wings, there are passages, guided outward from the indentations, with bottom surfaces guided downward at an incline.
